(19) United States
(12) Patent Application Publication
(10) Pub. No.: US 2009/0194187 A1
(43) Pub. Date: Aug. 6, 2009

(54) Application of Hydraulic Friction Reducing Internal Diameter Coatings for Fire Protection Piping

(75) Inventors: Bruce E. Laumann, Crown Point, IN (US); Stephen Norvilas, Doylestown, PA (US); Robert Bussiere, Frankfort, IL (US)

Correspondence Address: Tyco International Management Corp., 9 Roszel Road, Princeton, NJ, 08540, US

(73) Assignee: ALLIED TUBE & CONDUIT CORPORATION, Harvey, IL (US)

(21) Appl. No.: 12/365,659

(22) Filed: Feb. 4, 2009

Related U.S. Application Data
(60) Provisional application No. 61/026,229, filed on Feb. 5, 2008.

(51) Int. Cl. F16L 9/14

(52) U.S. Cl. 138/146; 138/141; 138/143

(57) ABSTRACT

The present invention relates to in-line coating of a continuously moving substrate, such as a tube or conduit, preferably of the type used for applications such as fire sprinkler piping. The present invention includes a fire sprinkler pipe defining an internal pathway. The interior surface of the pipe is coated with a low friction material such as a fluoropolymer, silicone or epoxy composition.

### CROSS-REFERENCE TO RELATED APPLICATIONS

This application claims priority to U.S. Provisional Application No. 61/026229 filed Feb. 5, 2008 which is incorporated herein by reference in its entirety.

### BACKGROUND

1. Field of the Invention

The present invention is directed to tubing, piping, conduit and the like. More particularly, the present invention relates to the coating of the interior wall or surface of pipe used in fire sprinkler or non-potable water transfer systems where the coating has a low friction composition to provide low flow resistance, both immediately and over time.

2. Discussion of Related Art

The art of forming and coating tubes, pipes and conduits (hereinafter referred to generally as “pipe” and or “pipes”) is well-established. To form a pipe, strip steel in the form of coils is supplied from a pay-out reel in a pipe forming mill or line. The strip steel is supplied to one or more tube forming rollers in a tube forming station to bring the longitudinal edges of the strip steel together. The edges are then welded together to form a pipe having a generally circular cross-section. The pipe may be subsequently treated (e.g. galvanized) and cut to a desired length. The various steps in this process are provided are aligned along the central axis of the pipe and is continuous within a mill to produce pipe at relatively high rates of speed.

Galvanizing is a process where the formed pipe is exposed to a zinc coating on the outside wall of the pipe. Galvanizing takes advantage of the protective properties of zinc which is more resistant to corrosion than the underlying steel pipe. Advances in pipe manufacturing and galvanizing have resulted in the production of continuous pipes at rapid speeds on the order of six hundred feet per minute. Galvanizing has also progressed through the elimination of secondary or elevated zinc containers in favor of zinc pumped through cross-tees, spray nozzles and drip nozzles. Application dwell times of zinc during galvanizing have been reduced to tenths of seconds and contact zones of the pipe upon which the zinc is applied have similarly been reduced to inches. Preferred methods for coating pipes are described in U.S. Pat. Nos. 6,063,452 and 6,197,394, herein incorporated by reference. However, these processes are related to coating on the outside walls of the pipe not the inside wall of the centrally disposed pathway.

U.S. patent application Ser. No. 5,718,027 (“the '027 patent”) discloses an apparatus for the interior painting of tubing during continuous formation of the pipe which is assigned to the assignee of the present invention the contents of which are herein incorporated by reference. The '027 patent teaches the use of a spraying means which is introduced into the pipe upstream of the welding station while providing the spraying means downstream of the processing stations for forming the pipe.

Fire protection systems (e.g. sprinkler systems) employ these types of coated pipes for installation within buildings or structures to provide fire suppression liquids or suppressants throughout the premises. These sprinkler systems are engineered and designed to provide the requisite amount of fire suppression fluid (e.g. water) to the desired area. However, the pipes used in these systems degrade over time. This is due, at least in part, to the theoretical eventual roughening of the pipe's internal diameter (I.D.) surface from oxidation (rust) or microbiological induced corrosion (M.I.C.) over the life of the pipes and systems. As such, higher hydraulic friction levels (i.e., greater resistance to flow values) are designed into these systems. One method used by manufacturers of fire sprinkler piping to overcome this degradation problem is to produce plastic lined piping with a separate plastic insert sleeve within the interior pathway of the pipe. However, such plastic lined piping has poor heat resistance to fire combustion temperatures, causes changes in the dimension of the I.D. of the piping, has a high potential for delamination, and requires special tooling and fittings for pipe fabrication not routinely found in the fire protection industry. Thus, there is a need to provide a pipe that has a low hydraulic friction level for employment in fire sprinkler systems.

### SUMMARY OF THE INVENTION

Exemplary embodiments of the present invention are directed to a low friction fluid transport device or pipe. In an exemplary embodiment, the low friction fluid transport device comprises a length of conduit which defines a pathway therethrough. At least one inner surface surrounds the pathway where the pathway has a transverse inner dimension. A coating of fluoropolymeric, silicone or epoxy material is disposed at least partially over the inner surface of the conduit. The material is configured to maintain the inner dimension of the conduit.

The present invention relates to the in-line coating of a continuously moving pipe or tube, preferably of the type used for applications such as fire sprinkler piping. The present invention includes a fire sprinkler pipe having a wall defining a pathway therethrough. The pathway has an inner dimension and at least one surface surrounding the pathway defined by the wall. A coating is at least partially disposed over the inner surface of the wall. The coating is configured to reduce the resistance to flow of liquid media within the pathway. The low friction coating includes, but is not limited to a fluoropolymer, silicone or epoxy composition.

### BRIEF DESCRIPTION OF THE DRAWINGS

FIG. 1 is a schematic diagram of an exemplary process in accordance with the present invention;

FIG. 2 is a perspective view of an exemplary apparatus used to coat the inner surface of a pipe in accordance with the present invention;

FIG. 3 is a cross sectional schematic diagram of an exemplary conduit or pipe having a coated inner surface in accordance with the present invention.

### DESCRIPTION OF EMBODIMENTS

The present invention will now be described more fully hereinafter with reference to the accompanying drawings, in which preferred embodiments of the invention are shown. This invention, however, may be embodied in many different forms and should not be construed as limited to the embodiments set forth herein. Rather, these embodiments are provided so that this disclosure will be thorough and complete, and will fully convey the scope of the invention to those skilled in the art. In the drawings, like numbers refer to like elements throughout.

The present invention includes a sprinkler pipe, and methods of manufacturing the sprinkler pipe having a pathway having an internal diameter (I.D.) or internal dimension where the surface surrounding the pathway is coated to maintain the I.D. and maintain the internal diameter or dimension, resistance to heat associated with fire combustion as well as providing a low hydraulic friction surface as compared to known internally painted pipes and conduit. As such, incorporation of a coating to the interior surface of the sprinkler pipe pathway results in a low resistance to flow of liquids therein for extended periods of time to maintain the operation of associated sprinkler systems. Additionally, the lower friction factor (less resistance to flow) results in conservation and reduction in the required liquid handling equipment such as the required liquid pumping power and pipe diameter for these systems.

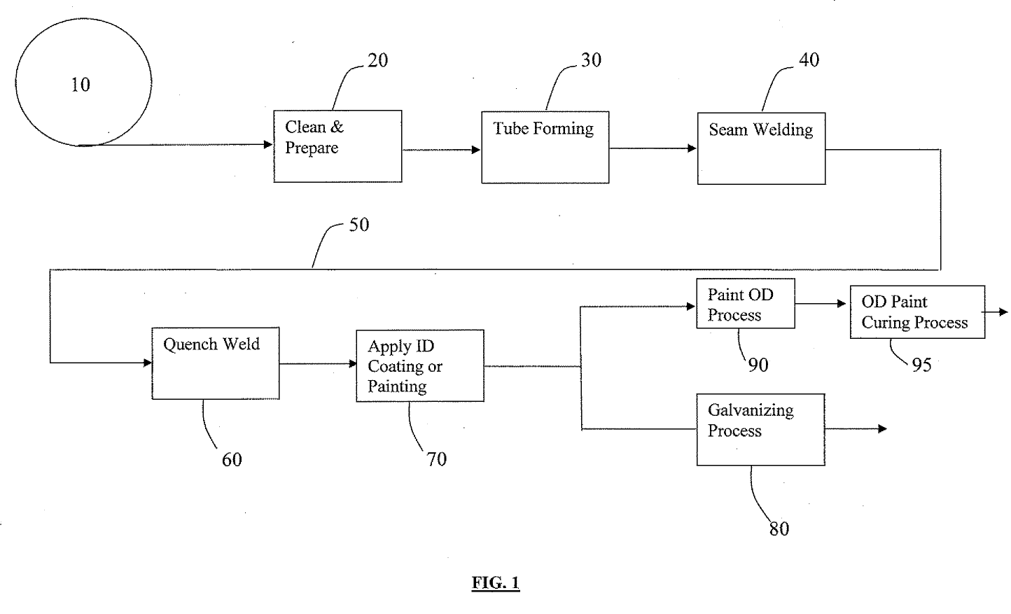

FIG. 1 is a schematic diagram of an exemplary process for continuous fabrication of pipe. Strip steel 5 is uncoiled from a supply role 10, cleaned and prepared in a cleaning station 20. The strip steel 5 is then provided to a forming station 30 which includes one or more rollers to form the strip steel. The longitudinal edges of the strip steel 5 are brought together by the rollers. When the edges are contiguous, they are welded together, in line, in a seam welding station 40 to form a pipe 50 having a substantially circular cross-section and an internal pathway. Alternative cross sections including, for example, oval, square, rectangle, oblong, etc., may also be employed depending on the desired application. Typical welding temperatures for the strip steel are in the range of 2500° F. The welded pipe 50 undergoes a quench weld where water is applied around the outside of the pipe to provide sufficient cooling after the welding process. A coating is applied to the surface of the internal pathway of the pipe at station 70. This coating may be, for example, a fluoropolymer, silicone or epoxy composition applied as liquid paint. Of these, fluoropolymers are particularly preferred. The pipe is then moved to a galvanizing station 80 in which a zinc coating is applied to the exterior of the pipe at or above the melting point of zinc which is in the range of 850° F. The fluoropolymer applied to the interior surface of the pipe can withstand the heat range associated with galvanizing. In addition, because the fluoropolymer, silicone or epoxy is applied as a liquid paint, the solvents associated with the paint must be evaporated or volatilized. This is accomplished during the galvanizing process. Alternatively, if galvanizing is not desired for a particular application, the outer surface of the pipe (which has an outer diameter (O.D.) or outer dimension) is painted at station 90. This O.D. paint is then cured at a given temperature at station 95 as required for the particular paint. This O.D. curing process also acts to evaporate the solvents associated with the paint used for the coating applied to the interior surface of the pathway. The fluoropolymer used to coat the interior surface of the pipe may be a thermoset or a thermoplastic. If the fluoropolymer is a thermoset, the heat from the galvanizing process or the heat used to cure the O.D. paint is also used to cross-link the thermoset fluoropolymer. If the fluoropolymer is a thermoplastic, no cross-linking is required to cure the interior surface coating. After galvanizing at station 80 or paint curing at step 95, the coated pipe 50 is cut to the desired length. In this manner, a continuous process is used to form strip steel into pipe having in which a low friction coating is applied to the interior surface of the pipe.

A fluoropolymer is preferred for coating the interior pathway of the pipe because it provides low hydraulic friction which results in less resistance to fluid flow through the pipe. In addition, the fluoropolymer coating provides a non-degrading barrier protection to the interior steel surface. A fluoropolymer is a fluorocarbon based polymer with relatively strong carbon-fluorine bonds. Because fluoroploymers have low surface energy these chemical compounds demonstrate non-stick and friction reducing characteristics. Similarly, due to the low viscosity and surface tension of the liquid paint, the coating fills in microscopic roughness of the base metal surface profile to provide a smoother, lower roughness profile which lowers water flow resistance without significantly affecting the internal flow pathway diameter of the pipe. This provides the interior pathway of the sprinkler pipe with less resistance for the flow of fire suppressant liquids therein. Consequently, less pressure is needed to displace the liquid within the fire sprinkler system and smaller diameter pipes may replace larger diameter pipes. In addition, the fluoropolymer coatings prevent the interior surface of the pipe pathway from degradation due to rusting, natural water borne minerals, water treatment chemical additives or byproducts and/or microbially influenced corrosion (M.I.C.). Moreover, the fluoropolymer coating has greater heat resistance than common paints and better resists the fire combustion temperatures subjected to steel sprinkler piping during operation.

The present invention is particularly useful in fire sprinkler piping systems needing corrosion protection, lower hydraulic friction and greater heat resistance. The Hazen-Williams equation is typically used in the design of fire sprinkler systems as well as other water piping systems. This equation is an empirical formula which relates the flow of water in a pipe with the physical properties of the pipe and the pressure drop caused by friction therein. In particular, the Hazen-Williams equation provides a relationship of the mean velocity of water in a pipe with the geometric properties or shape of the pipe and the slope of the energy line in which V=kCR^{0.63}S^{0.54} where k is the conversion factor the unit system (k=1.318 for US units); C is the roughness coefficient of the interior of the pipe, R is the hydraulic radius and S is the slope of the energy line. It is current sprinkler systems design practice to use the Hazen-Williams friction design factor of 120. This is used despite the fact that the actual physically occurring factor is 140-160 (lower resistance to flow than 120) because of the expected degradation of the smoothness of the interior pathway of the pipe to 120. The present invention prevents degradation of the smoothness of the internal diameter surface of the pipe. In addition, the expected 140-160 friction factor may be preserved over the life of the system without the need to design future degradation into the sprinkler system parameters. This lower resistance to flow within the pipes conserves fluid handling resources, such as lower horsepower or kilowatt pumps to provide identical flow through the pipes at lower pressure or the use of smaller diameter piping within the system. Other applications include systems having liquid flow of corrosive liquids such as, but not limited to, sewage, acidic food ingredients and/or associated by-products.

FIG. 2 illustrates an exemplary device, referred to as a lance 100, used to apply the fluoropolymer, silicone or epoxy coating to the interior surface of a pipe 50 at station 70 (shown with reference to FIG. 1). The lance 100 includes a spray nozzle portion 138 connected to a hose 150. The lance is inserted into the pipe 50 downstream of the seam weld station 40 a sufficient distance to allow the weld point to cool using the quench weld station 60. This cooling period is needed to allow the fluoropolymer paint coating to be successfully applied to the interior surface 51 of the interior pathway 52 of pipe 50. Otherwise the interior surface 51 will be too hot to obtain a continuous coating and will compromise the desired low friction characteristic of the interior pathway of the pipe. It has been found that a distance of approximately 15-30 feet is needed from the weld point to cool the pipe sufficiently to apply the interior coating. This distance is dependent on the pipe wall thickness where pipe walls which are thicker or heavier contain more heat than thin wall pipe due to the greater mass/unit area, and thus more heat/unit area. Transferring heat out of the heavier wall through quenching takes longer times and distances as more heat must be removed from thicker/heavier pipe. The spray nozzle portion 138 includes a spray head 140 having a hollow cone shape with a circular cross section to impart a circular pattern of the coating onto the interior surface 51 of pipe 50. It is important to note that the coating may be applied directly to the interior steel surface of the pipe 50 or may be applied on intermediate coatings applied to the interior surface 51 prior to or in combination with application of the fluoropolymer coating. The spray device also includes a plurality of bow supports 152 which project laterally out from the spray nozzle portion 138 a consistent distance toward the interior surface 51. This allows the spray head 140 to be centered within the interior pathway 52 for even application of the coating to the interior surface 51 of pipe 50.

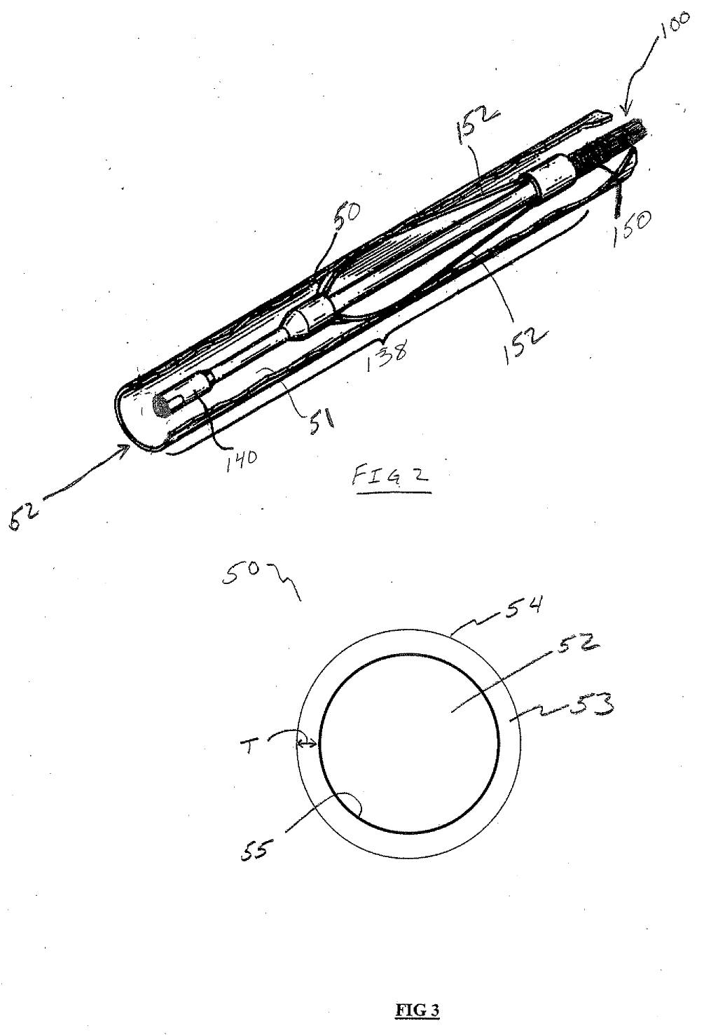

FIG. 3 illustrates a schematic cross-section of pipe 50 defined by interior pathway 52 having a central axis extending the length of the pipe. Again, although pipe 50 is shown with a generally circular cross-section, alternative geometries may also be employed having an internal pathway dimension. Pipe 50 includes a wall 53 formed from rolled strip steel having a desired thickness ‘T’ and an outer surface 54. The interior surface 51 of wall 53 includes a coating 55 disposed thereon. The coating 55 is applied sufficiently to the interior surface to provide a low hydraulic friction surface which results in less resistance to fluid flow through the internal pathway 52 of pipe 50. As described above, the coating 55 may be a fluoropolymer composition which is filtered and adjusted to a proper viscosity range for the application equipment described with reference to FIG. 2. It has been found that the enhanced smoothness of the interior pathway 52 provided by the coating 55 prevents bacteria from attaching to the interior surface 51 of the pipe, as evidenced by negligible bacteria growth on tested samples. Similarly, fluoropolymers are non-biodegradable and do not act as a nutrient medium to support bacterial, viral or fungal growth. Additionally, pipes so treated had more favorable hydraulic coefficients than uncoated pipe, which may be attributable to there being no or at least significantly less microbially influenced corrosion as a result of the coatings employed in the present invention.

While the present invention has been disclosed with reference to certain embodiments, numerous modifications, alterations and changes to the described embodiments are possible without departing from the sphere and scope of the present invention, as defined in the appended claims. Accordingly, it is intended that the present invention not be limited to the described embodiments, but that it has the full scope defined by the language of the following claims, and equivalents thereof.

What is claimed is:

1. A low friction fluid transport device comprising,
a length of conduit defining a pathway therethrough, said conduit having an inner dimension;
at least one inner surface surrounding said pathway; and
at least one layer of fluoropolymeric material at least partially disposed over the inner surface of the conduit, wherein said fluoropolymeric material is configured to maintain the inner dimension of said conduit.

2. The low friction fluid transport device of claim 1 wherein the conduit comprises a steel pipe.

3. The low friction fluid transport device of claim 1 wherein said inner dimension is an inner diameter of said conduit.

4. The low friction fluid transport device of claim 1 wherein said fluoropolymeric material provides said conduit with a relatively low hydraulic friction coefficient such that resistance to fluid flow through the conduit is significantly less as compared to a conduit without said fluoropolymeric material at least partially disposed over the inner surface of the conduit

5. A low friction fluid transport device comprising,
a length of conduit defining a pathway therethrough, said conduit having an inner dimension;
at least one inner surface surrounding said pathway; and
at least one layer of silicone material at least partially disposed over the inner surface of the conduit, wherein said silicone material is configured to maintain the inner dimension of said conduit.

6. The low friction fluid transport device of claim 5 wherein the conduit comprises a steel pipe.

7. The low friction fluid transport device of claim 5 wherein said inner dimension is an inner diameter of said conduit.

8. The low friction fluid transport device of claim 5 wherein said silicone material provides said conduit with a relatively low hydraulic friction coefficient such that resistance to fluid flow through the conduit is significantly less as compared to a conduit without said silicone material at least partially disposed over the inner surface of the conduit.

9. A low friction fluid transport device comprising,
a length of conduit having a wall defining a pathway therethrough, said pathway having an inner dimension;
at least one surface surrounding said pathway defined by said wall; and
a coating at least partially disposed over the inner surface of the wall, said coating configured to reduce the resistance to flow of liquid media within said pathway.

10. The low friction fluid transport device of claim 9 wherein said coating is a fluoropolymer.

11. The low friction fluid transport device of claim 9 wherein said coating is a silicone.

12. The low friction fluid transport device of claim 9 wherein said coating is an epoxy.

13 The low friction fluid transport device of claim 9 wherein said coating is a polymer which displays fluid transport properties similar to silicones or fluoropolymer.

14. The low friction fluid transport device of claim 9 wherein said conduit is a sprinkler pipe.
